(19) United States
(12) Patent Application Publication
(10) Pub. No.: US 2017/0104530 A1
(43) Pub. Date: Apr. 13, 2017

(54) TRANSMISSION APPARATUS AND METHOD FOR CONFIRMING CONNECTION OF OPTICAL FIBER

(71) Applicant: FUJITSU LIMITED, Kawasaki-shi (JP)

(72) Inventors: Hiroki Nagata, Fukuoka (JP); Masanori Eiro, Dazaifu (JP); Daisuke Kobayashi, Kasuya (JP); Tatsuo Nagayoshi, Ohnojyou (JP)

(73) Assignee: FUJITSU LIMITED, Kawasaki-shi (JP)

(21) Appl. No.: 15/274,179

(22) Filed: Sep. 23, 2016

(30) Foreign Application Priority Data
Oct. 9, 2015 (JP) 2015-201309

(51) Int. Cl. H04B 10/079; H04B 10/25; H04J 14/02; H04B 10/58

(52) U.S. Cl. CPC H04B 10/07955; H04B 10/58; H04B 10/2504; H04J 14/021

(57) ABSTRACT

There is provided a transmission apparatus, which includes: a filter configured to pass an optical signal having a predetermined wavelength received via an optical fiber, a variable optical attenuator configured to attenuate a power level of the optical signal passed by the filter, a first measuring circuit configured to measure a first power of the optical signal before being passed by the filter, a second measuring circuit configured to measure a second power of the optical signal attenuated by the variable optical attenuator, a detector configured to detect a difference between the first power and the second power, and a controller configured to increase an attenuation factor of the variable optical attenuator when the difference is equal to or larger than a first predetermined value.

### CROSS-REFERENCE TO RELATED APPLICATION

This application is based upon and claims the benefit of priority from the prior Japanese Patent Application No. 2015-201309, filed on Oct. 9, 2015, the entire contents of which are incorporated herein by references.

### FIELD

The embodiments discussed herein are related to a transmission apparatus and a method for confirming connection of an optical fiber.

### BACKGROUND

A reconfigurable optical add/drop multiplexer (ROADM) device multiplexes and transmits a plurality of optical signals having different wavelengths. The ROADM device is connected with a number of paths within a network, and an optical cross-connect unit for adding/dropping an optical signal for each wavelength is provided for each of the paths.

Optical signals transmitted from the optical cross-connect unit are received to itself or another optical cross-connect unit via a number of optical fibers passing through the other units. Therefore, when installing the ROADM device or extending an optical signal line, optical fiber connection confirmation is performed by transmitting/ receiving an optical signal for test (hereinafter, referred to as a “test optical signal”) between the optical cross-connect units (see, e.g., Japanese Laid-Open Patent Publication No. 2010-098677). At this time, a reception side optical cross-connect unit adjusts the power of the test optical signal to an appropriate value according to a dynamic range of a receiver by a variable optical attenuator (VOA) included in a wavelength selective switch (WSS).

Related technologies are disclosed in, for example, Japanese Laid-Open Patent Publication No. 2010-098677.

### SUMMARY

According to an aspect of the invention, a transmission apparatus includes: a filter configured to pass an optical signal having a predetermined wavelength received via an optical fiber, a variable optical attenuator configured to attenuate a power level of the optical signal passed by the filter, a first measuring circuit configured to measure a first power of the optical signal before being passed by the filter, a second measuring circuit configured to measure a second power of the optical signal attenuated by the variable optical attenuator, a detector configured to detect a difference between the first power and the second power, and a controller configured to increase an attenuation factor of the variable optical attenuator when the difference is equal to or larger than a first predetermined value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary outline of an ROADM device;

FIG. 2 is a diagram illustrating an exemplary outline of an optical cross-connect unit;

FIG. 3 is a flow chart illustrating an example of a method for confirming connection of an optical fiber;

FIGS. 4A to 4C are views illustrating exemplary wavelength spectra of ASE light, FIG. 4A illustrating an example of a wavelength spectrum of ASE light before power adjustment in a comparative example, FIG. 4B illustrating an example of a wavelength spectrum of ASE light after power adjustment in the comparative example, and FIG. 4C illustrating an example of a wavelength spectrum of ASE light and a test optical signal at the time of input of the test optical signal in the comparative example;

FIGS. 5A to 5C are views illustrating an example of a wavelength spectra, FIG. 5A illustrating an example of a wavelength spectrum of ASE light before passing through a filter, FIG. 5B illustrating an example of a wavelength spectrum of ASE light after passing through the filter, and FIG. 5C illustrating an example of a difference between the power of the ASE light before passing through the filter and the power of the ASE light after passing through the filter;

FIGS. 6A to 6C are views illustrating exemplary wavelength spectra, FIG. 6A illustrating an example of a wavelength spectrum of ASE light and a test optical signal before passing through a filter, FIG. 6B illustrating an example of a wavelength spectrum of ASE light and a test optical signal after passing through the filter, and FIG. 6C illustrating an example of a difference between the power of the ASE light and a test optical signal before passing through the filter and the power of the ASE light and test optical signal after passing through the filter;

FIG. 7 is a table illustrating an example of a measurement on a difference between the power before passing through the filter and the power after passing through the filter;

FIG. 8 is a flow chart illustrating an exemplary process of controlling an attenuation factor of a VOA;

FIG. 9 is a table illustrating an example of a measurement on a ratio of the power after passing through the filter to the power before passing through the filter; and

FIG. 10 is a flow chart illustrating another exemplary process of controlling the attenuation factor of the VOA.

### DESCRIPTION OF EMBODIMENTS

When an optical signal transmitted in an optical fiber passes through an erbium-doped fiber amplifier (EDFA), amplified spontaneous emission (ASE) light output from the EDFA is input to an optical cross-connect unit at a reception side. Therefore, when a test optical signal is being transmitted, the reception side optical cross-connect unit receives both of the test optical signal and the ASE light. When no test optical signal is being transmitted, the reception side optical cross-connect unit receives only the ASE light.

However, unless the test optical signal is transmitted from/received to one optical cross-connect unit, the reception side optical cross-connect unit may not be able to determine whether or not the test optical signal is being transmitted. Thus, even when receiving only the ASE light, the reception side optical cross-connect unit adjusts the ASE light to a proper power, like the test optical signal. At this time, since the power of the ASE light is smaller than that of the test optical signal, the attenuation factor of a VOA of the reception side optical cross-connect unit is controlled to a value lower than that in the power adjustment of the test optical signal.

In this state, when the test optical signal is input to the reception side optical cross-connect unit, a test optical signal with a high power exceeding a standard value of a reception power is input to a receiver of the reception side optical cross-connect unit, which may be likely to do damage to the receiver.

In contrast, when an optical cross-connect unit at a transmission side notifies a transmission timing of the test optical signal to the reception side optical cross-connect unit, the reception side optical cross-connect unit is able to increase the VOA attenuation factor in advance in response to this notification, avoiding the above-mentioned problem. However, in this case, there occurs a need to install a new control means between the optical cross-connect units, which may result in a separate problem of increase in costs and scale of ROADM devices.

In addition, when an optical channel monitor is installed in the reception side optical cross-connect unit, it is possible to monitor power for each channel in the unit of wavelength and determine the presence/absence of a test optical signal based on a result of the monitoring, avoiding the above-mentioned problem. However, since the optical channel monitor is large-sized and expensive, there may occur a separate problem of increase in costs and size of ROADM devices.

Hereinafter, a technique for preventing a receiver from being damaged by a test optical signal will be described with reference to the drawings.

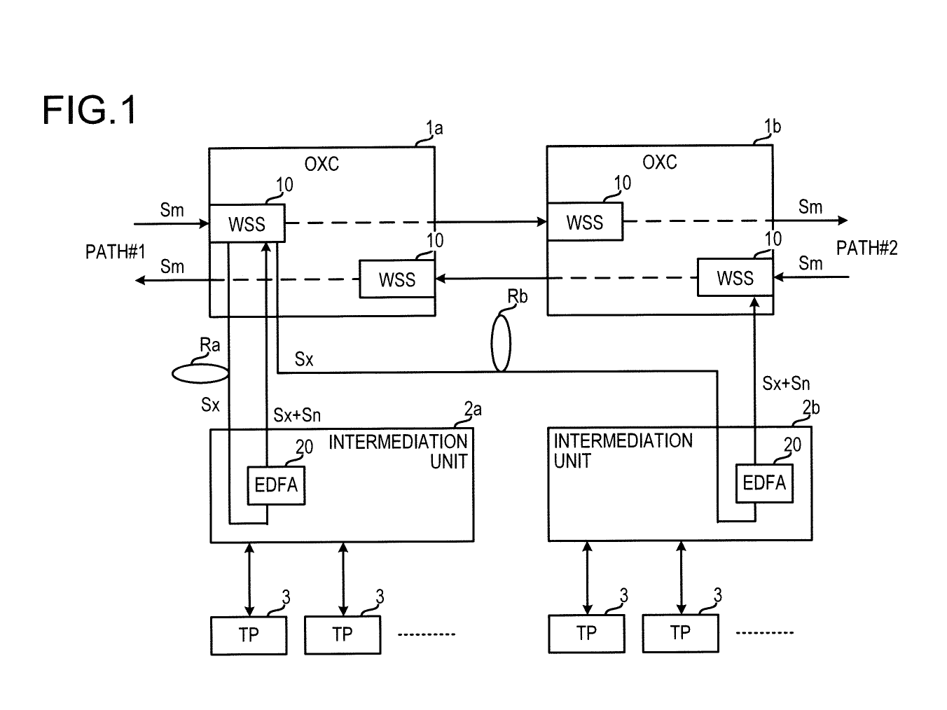

FIG. 1 is a diagram illustrating an exemplary outline of an ROADM device. An ROADM device wavelength-multiplexes a plurality of optical signals having different wavelengths and transmits a wavelength-multiplexed optical signal Sm among other devices. In addition, in this embodiment, the ROADM device is described as an example of the transmission apparatus, but the transmission apparatus is not limited to the ROADM device.

The ROADM device includes optical cross-connect units (OXCs) 1a and 1b, intermediation units 2a and 2b, and transponders (TPs) 3, for paths #1 and #2, respectively. The optical cross-connect units 1a and 1b transmit/receive the wavelength-multiplexed optical signal Sm with the paths #1 and #2, respectively. Each of the optical cross-connect units 1a and 1b includes a wavelength selective switch (WSS) 10 which adds an optical signal to the wavelength-multiplexed optical signal Sm for each wavelength or drops an optical signal from the wavelength-multiplexed optical signal Sm for each wavelength. The detailed configuration of the optical cross-connect units 1a and 1b will be described later.

The TPs 3 transmit/receive an optical signal having a specific wavelength, which is a client signal, with the optical cross-connect units 1a and 1b via the intermediation units 2a and 2b. Each of the intermediation units 2a and 2b includes an EDFA 20 provided on an optical signal path. The EDFAs 20 are arranged in an array form and amplify optical signals.

The WSS 10 separates the wavelength-multiplexed optical signal Sm input from each path #1 and #2 by the unit of wavelength, i.e., the unit of channel. The WSS 10 selects a wavelength to be dropped, from the separated optical signals, and outputs the corresponding optical signal to each TP 3 via each intermediation unit 2a and 2b. In this way, an optical signal having a specific wavelength is dropped from the wavelength-multiplexed optical signal Sm.

Further, the WSS 10 multiplexes optical signals input from the TPs 3 via the intermediation units 2a and 2b on the wavelength-multiplexed optical signal Sm and outputs the multiplexed optical signals to the paths #1 and #2. In this way, an optical signal having a specific wavelength is added to the wavelength-multiplexed optical signal Sm.

The WSSs 10 of the optical cross-connect units 1a and 1b of different paths #1 and #2 are connected to each other via a plurality of optical fibers. In addition, the WSSs 10 of the optical cross-connect units 1a and 1b are connected to the intermediation units 2a and 2b via a plurality of optical fibers. This connection configuration allows the ROADM device to add/drop an optical signal of any TP 3.

The optical cross-connect units 1a and 1b and the intermediation units 2a and 2b are connected to each other via optical fibers corresponding to at least the maximum number of channels. In addition, although the number of the paths is two (2) in this embodiment, since the number of the optical cross-connect units 1a and 1b also increases with an increase in the number of the paths, the internal components of the ROADM device are connected to each other by a number of optical fibers.

Therefore, when installing the ROADM device or extending an optical signal line, optical fiber connection confirmation is performed by transmitting/receiving a test optical signal Sx between same or different optical cross-connect units 1a and 1b. At this time, each of the reception side optical cross-connect units 1a and 1b adjusts the power of the test optical signal Sx to an appropriate value according to the dynamic range of a receiver by a variable optical attenuator (VOA) included in the WSS 10.

Thus, the optical cross-connect units 1a and 1b transmit the test optical signal Sx and receive the test optical signal Sx via optical fibers. The test optical signal Sx has a predetermined wavelength λ different from the wavelengths of the optical signals and is transmitted/received via the WSS 10. The test optical signal Sx has a signal ID for identifying the test optical signal Sx. When the signal ID of the test optical signal Sx matches an expected value, the reception side optical cross-connect units 1a and 1b determine that the connection of the optical fiber is normal. In addition, the intermediation units 2a and 2b are coupled to the optical fibers and amplify the test optical signal Sx.

When optical fibers as denoted by reference symbols Ra and Rb pass through the EDFA 20, ASE light Sn output from the EDFA 20 is input to the reception side optical cross-connect units 1a and 1b. The optical fiber Ra is connected from the WSS 10 of the optical cross-connect unit 1a of the path #1, via the EDFA 20 of the intermediation unit 2a, to return to the WSS 10 as a transmission source. In addition, the optical fiber Rb is connected from the WSS 10 of the optical cross-connect unit 1a of the path #1, via the EDFA 20 of the intermediation unit 2b, to the WSS 10 of the optical cross-connect unit 1b of the path #2.

Therefore, when the test optical signal Sx is transmitted (hereinafter, referred to as a “test state”), the reception side optical cross-connect units 1a and 1b receive the test optical signal Sx and the ASE light Sn. When the test optical signal Sx is not transmitted (hereinafter, referred to as a “normal state”), the reception side optical cross-connect units 1a and 1b receive only the ASE light Sn.

When performing connection confirmation of the optical fiber Ra, since the transmission side optical cross-connect unit 1a and the reception side optical cross-connect unit 1a are the same units, the optical cross-connect units 1a may determine the test state and the normal state.

Meanwhile, when performing connection confirmation of the optical fiber Rb, since the transmission side and reception side optical cross-connect units 1a and 1b are separate units, that is, units having different mounting boards, it is impossible to discriminate between the test state and the normal state. In this case, since the reception side optical cross-connect unit 1b may incorrectly determine the ASE light Sn as the test optical signal Sx, and accordingly, perform the power adjustment, thereby damaging the receiver of the test optical signal Sx, the optical cross-connect unit has the following configuration.

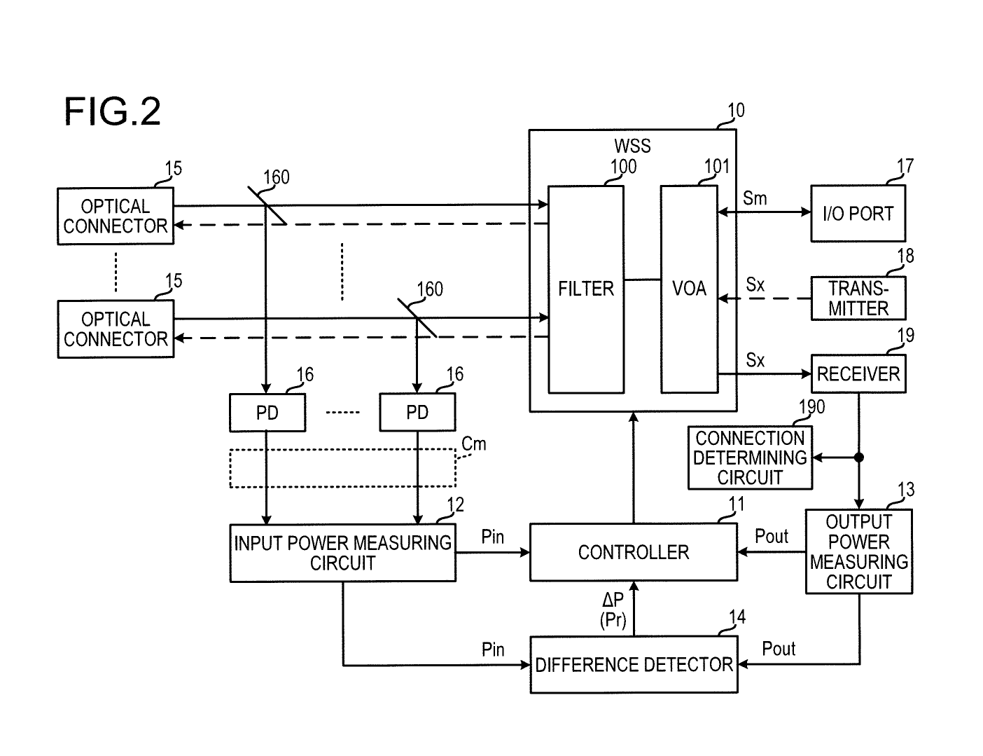

FIG. 2 is a view illustrating an exemplary outline of the optical cross-connect units 1a and 1b. The optical cross-connect units 1a and 1b each includes a WSS 10, a controller 11, an input power measuring circuit 12, an output power measuring circuit 13, a difference detector 14, a plurality of optical connectors 15, a plurality of photo detectors (PDs) 16, and an input/output port 17. The optical cross-connect units 1a and 1b each further includes a transmitter 18, a receiver 19, a plurality of demultiplexers 160, and a connection determining circuit 190. The WSS 10 includes a filter 100 and a VOA 101.

The optical connectors 15 are connected to other optical cross-connect units 1b and 1a or intermediation units 2a and 2b via optical fibers. Within the optical cross-connect units 1a and 1b, the optical connectors 15 are connected to the filter 100 within the WSS 10 via the demultiplexers 160. The number of installed optical connectors 15 amounts to at least the maximum number of channels.

The filter 100 passes an optical signal of each channel input from each optical connector 15 and outputs the optical signal to the VOA 101. In addition, a wavelength band of each channel passed by the filter 100 is set by the controller 11.

The VOA 101 attenuates an optical signal for each channel. Each optical signal attenuated by the VOA 101 is wavelength-multiplexed and is then output as a wavelength-multiplexed optical signal Sm to the input/output part 17. An attenuation factor of the VOA 101 for each channel is set by the controller 11.

A wavelength-multiplexed optical signal Sm is input/output between the input/output port 17 and other device. A wavelength-multiplexed optical signal Sm input from the VOA 101 is output from the input/output port 17 to other device.

In addition, a wavelength-multiplexed optical signal Sm input from the input/output port 17 is input to the WSS 10 and separated into optical signals for different channels which are then output to other optical cross-connect units 1b and 1a via the VOA 101, the filter 100, and the optical connectors 15 in this order.

The optical cross-connect units 1a and 1b function as either a transmission side unit for transmitting a text optical signal Sx or a reception side unit for receiving the test optical signal Sx. To this end, the transmitter 18 for transmitting the test optical signal Sx and the receiver 19 for receiving the test optical signal Sx are connected to the WSS 10.

The transmitter 18 is, for example, a laser diode (LD). In the transmission side optical cross-connect unit 1a, the transmitter 18 generates a test optical signal Sx having a predetermined wavelength λ different from that of the optical signal of each channel and outputs the test optical signal Sx to the WSS 10 (see the dashed line). The test optical signal Sx input to the WSS 10 is attenuated by the VOA 101 and then passed by the filter 100. At this time, the controller 11 sets the attenuation factor of the VOA 101 to, for example, a minimum value in preparation for s transmission loss of power of the test optical signal Sx by the optical fibers. The test optical signal Sx that has passed the filter 100 is output to the reception side optical cross-connect unit 1b via one of the optical connectors 15 (see the dashed line).

As described above, the reception side optical cross-connect unit 1b receives the test optical signal Sx and the ASE light Sn in the test state, and receives only the ASE light in the normal state. Therefore, in the following description, the ASE light Sn or a mixture of the test optical signal Sx and the ASE light Sn will be referred to as “input light” to be adapted to both of the test state and the normal state.

The input light is input from one of the optical connectors 15 of the reception optical cross-connect unit 1b via an optical fiber. The input light is demultiplexed by the demultiplexer 160 and input to each of the WSS 10 and the PD 16. An example of the demultiplexer 160 may include, but is not limited to, an optical splitter.

The PD 16 detects the intensity of the input light and converts the input light into an electrical signal which is output to the input power measuring circuit 12. The input power measuring circuit 12 is an example of a first measuring circuit and measures the power Pin of the input light before being passed by the filter 100. The input light power Pin is notified to the controller 11 and the difference detector 14. In addition, the number of the installed PDs 16 and demultiplexers 160 is equal to the number of the optical connectors 15.

In the meantime, the input light input to the WSS 10 reaches the filter 100 and passes through the VOA 101. The filter 100 transmits a light component of the input light which has the same wavelength (λ) band as the test optical signal Sx.

The VOA 101 attenuates the light component passed by the filter 100. The light component that has passed the VOA 101 is input to the receiver 19. The receiver 19 is, for example, a PD and detects, for example, the intensity of the test optical signal Sx and converts the test optical signal Sx into a test electrical signal which is output to the connection determining circuit 190 and the output power measuring circuit 13.

In the test state, the connection determining circuit 190 extracts a signal ID from the test electrical signal and compares the extracted signal ID with an expected value. When the signal ID matches the expected value, the connection determining circuit 190 makes a normal notification to an external terminal or the like in order to notify that optical fiber connection is normal. When the signal ID does not match the expected value, the connection determining circuit 190 makes an abnormal notification to the external terminal or the like in order to notify that optical fiber connection is abnormal.

The output power measuring circuit 13 is an example of a second measuring circuit and detects, for example, the intensity of the test electrical signal to measure the power Pout of a light component after being attenuated by the VOA 101. The light component power Pout is notified to the controller 11 and the difference detector 14.

The controller 11 controls the transmission band of the filter 100 and the attenuation factor of the VOA 101. The controller 11 includes a function to determine the test state and the normal state, as described later.

In the test state, the controller 11 controls the attenuation factor of the VOA 101 based on the power Pin notified from the input power measuring circuit 12 and the power Pout notified from the output power measuring circuit 13. At this time, the controller 11 adjusts the power of the test optical signal Sx input to the receiver 19 to an appropriate value according to the dynamic range of the receiver 19. Accordingly, the connection determining circuit 190 may extract the signal ID from the test optical signal Sx.

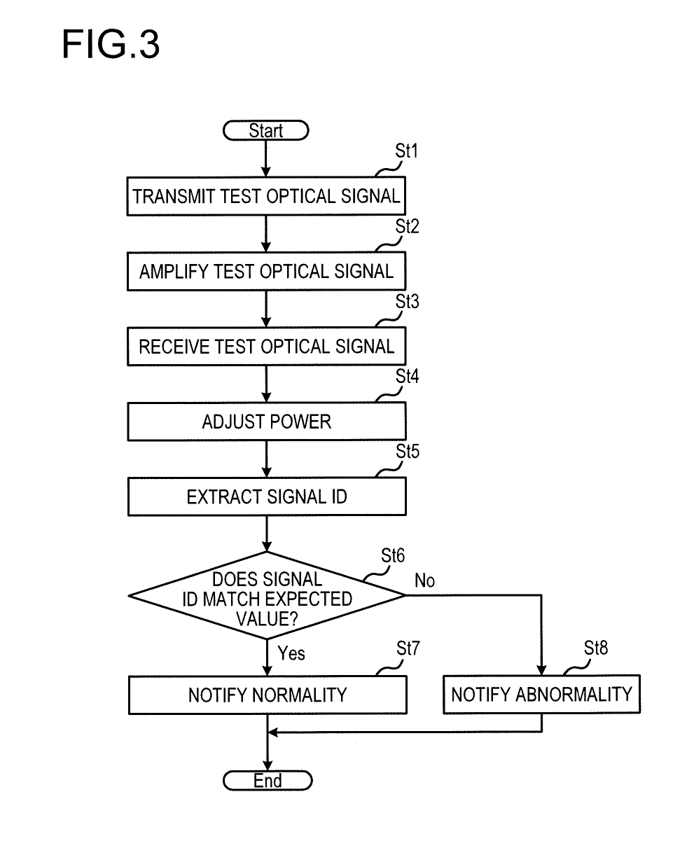

FIG. 3 is a flow chart illustrating an example of a method for confirming connection of an optical fiber. In this example, a case of performing confirmation of connection of the optical fiber Rb of FIG. 1 will be described.

First, the transmission side optical cross-connect unit 1a transmits the test optical signal Sx from the transmitter 18 via the optical fiber Rb (Operation SU). Next, the EDFA 20 of the intermediation unit 2b amplifies the test optical signal Sx (Operation St2).

Next, the reception side optical cross-connect unit 1b receives the test optical signal Sx via the optical fiber Rb (Operation St3). More specifically, the test optical signal Sx is input from the optical connector 15 into the optical cross-connect unit 1b.

Next, the controller 11 adjusts the power of the test optical signal Sx by controlling the attenuation factor of the VOA 101 (Operation St4). Next, the connection determining circuit unit 190 extracts a signal ID from the test optical signal Sx (Operation St5).

Next, the connection determining circuit 190 determines whether or not the signal ID matches an expected value (Operation St6). When it is determined that the signal ID matches the expected value (Yes in Operation St6), the connection determining circuit 190 outputs the normal notification (Operation St7). When it is determined that the signal ID does not match the expected value (No in Operation St6), the connection determining circuit 190 outputs the abnormal notification (Operation St8). In this way, the method for confirming the connection of an optical fiber is carried out.

In the above-described connection confirming method, when the controller 11 does not include the function to determine the test state and the normal state, the controller 11 also adjusts the power of the ASE light Sn even in the normal state as described below. Hence, at the input time of the test optical signal Sx, the receiver 19 may be damaged by the test optical signal Sx.

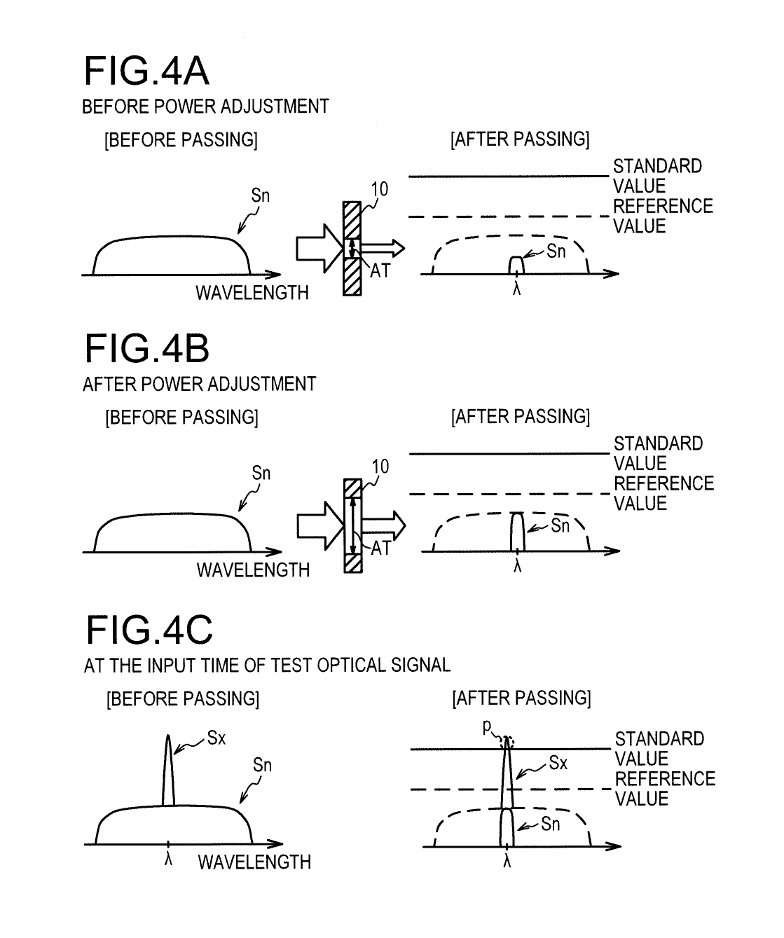

FIG. 4A illustrates an exemplary wavelength spectrum of the ASE light Sn before power adjustment in a comparative example. In FIG. 4A, the term “before passing” represents a spectrum waveform of the ASE light before passing through the WSS 10, and the term “after passing” represents a spectrum waveform of the ASE light after passing through the WSS 10.

In addition, the reference symbol AT represents a degree of narrowing of the power of the test optical signal Sx in the VOA 101 within the WSS 10, that is, the inverse of the attenuation factor of the VOA 101 within the WSS 10. The term “reference value” indicates an appropriate value of the power of light received by the receiver 19, and the term “standard value” indicates a limit value of the power of light received by the receiver 19. The receiver 19 may be damaged when receiving light of a power that exceeds the standard value.

As understood from the waveform of “after passing,” when the ASE light Sn passes through the WSS 10, only a light component having a wavelength (λ) band is passed by the filter 100. In addition, since the attenuation factor of the VOA 101 is set to a maximum value, the power of the ASE light Sn after passing is smaller than that before passing.

FIG. 4B illustrates an exemplary wavelength spectrum of the ASE light Sn after power adjustment in the comparative example. The reference symbols and notation in FIG. 4B have the same meanings as those in FIG. 4A.

Even when receiving only the ASE light Sn (i.e., in the normal state), the controller 11 adjusts the ASE light Sn to an appropriate power, like the test optical signal Sx. At this time, since the power of the ASE light Sn is smaller than the power of the test optical signal Sx, the attenuation factor of the VOA 101 is controlled to be lower than that in the power adjustment of the test optical signal Sx, as indicated by the reference symbol AT. For example, the attenuation factor of the VOA 101 is controlled to a lowest value.

Therefore, the power of the ASE light Sn after passing is larger than that before the power adjustment (the case of FIG. 4A). In addition, since the power of the ASE light Sn is originally smaller than the power of the test optical signal Sx, the power of the ASE light Sn does not reach the reference value of the receiver 19.

FIG. 4C illustrates an exemplary wavelength spectrum of the ASE light Sn and test optical signal Sx at the input time of the test optical signal Sx in the comparative example. More specifically, FIG. 4C illustrates a wavelength spectrum when the test optical signal Sx is input (that is, in the test state) in the state of FIG. 4B. The reference symbols and notation in FIG. 4C have the same meanings as those in FIG. 4A.

The test optical signal Sx has a predetermined wavelength (λ) band and passes through the WSS 10 in a state of being mixed with the ASE light Sn. At this time, the attenuation factor of the VOA 101 within the WSS 10 is set to a lowest value as in FIG. 4B.

Therefore, the test optical signal Sx is input to the receiver 19 with being little attenuated. Thus, since a test light signal Sx of high power exceeding the standard value as well as the reference value is inputted to the receiver 19, as indicated by the reference symbol p, there is a possibility that the receiver 19 is damaged.

In this way, since the controller 11 of the comparative example cannot determine the test state and the normal state, the controller 11 lowers the attenuation factor of the VOA 101 to the lowest value based on the low power of the ASE light Sn when only the ASE light Sn is input. When the test optical signal Sx is input in this state, since the power of the test optical signal Sx is higher than the power of the ASE light Sn, the test optical signal Sx is input to the receiver 19 without being sufficiently attenuated. Therefore, since the test optical signal Sx of the power exceeding the standard value is input to the receiver 19, there is a possibility of damage to the receiver 19.

In contrast, in FIG. 1, when the transmission timing of the test optical signal Sx is notified from the transmission side optical cross-connect unit is to the reception side optical cross-connect unit 1b, the reception side optical cross-connect unit 1b may increase the attenuation factor of the VOA 101 in advance in response to this notification, avoiding the above-mentioned problem. However, in this case, there occurs a need to install a new control means between the optical cross-connect units 1a and 1b , which may result in an increase in costs and scale of the ROADM device.

In addition, as illustrated in FIG. 2, for example, when an optical channel monitor Cm is provided in the reception side optical cross-connect unit 1b, it is possible to monitor power for each channel in the unit of wavelength and determine the presence/absence of the test optical signal Sx based on a result of the monitoring, avoiding the above-mentioned problem. However, since the optical channel monitor Cm is large-sized and expensive, it may increase the costs and the size of the ROADM device.

Therefore, in one embodiment, a difference between the power Pin of the input light before passing through the filter 100 and the VOA 101 and the power Pout of the input light after passing through the filter 100 and the VOA 101 is measured, and when the difference is larger than a predetermined threshold, the attenuation factor of the VOA 101 is increased to suppress the receiver 19 from being damaged. This configuration will be described below with reference to FIG. 2 again.

The difference detector 14 detects a difference between the power of the input light before passing through the WSS 10 and the power of the input light after passing through the WSS 10. More specifically, the difference detector 14 is an example of a detector and detects a difference ΔP (=Pin−Pout) between the power Pin measured by the input power measuring circuit 12 and the power Pout measured by the output power measuring circuit 13.

The difference detector 14 notifies the detected difference ΔP to the controller 11. In addition, the difference detector 14 may detect a ratio Pr of the power Pout measured by the output power measuring unit 13 to the power Pin measured by the input power measuring circuit 12 and notify the detected ratio Pr to the controller 11, as described later. The difference ΔP will first be described below.

The controller 11 determines the normal state and the test state based on the difference ΔP notified from the difference detector 14. When the difference ΔP is equal to or larger than a predetermined threshold Pth, the controller 11 determines that the transmission side optical cross-connect unit 1a is in the normal state. When the difference ΔP is smaller than the predetermined threshold Pth, the controller 11 determines that the transmission side optical cross-connect unit 1a is in the test state.

In the normal state, the controller 11 increases the attenuation factor of the VOA 101. Accordingly, since the attenuation factor of the VOA 101 may be set to a high value when the test optical signal Sx is input, the test optical signal Sx is input to the receiver 19 after being sufficiently attenuated. As a result, since the power of the test optical signal Sx becomes lower than the standard value of the receiver 19, there is no possibility of damage to the receiver 19.

Meanwhile, in the test state, the controller 11 controls the attenuation factor of the VOA 101 such that the power Pout measured by the output power measuring circuit 13 has a predetermined value. Accordingly, the controller 11 may adjust the power of the test optical signal Sx to an appropriate value according to the dynamic range of the receiver 19.

In this way, the controller 11 compares the difference ΔP and the threshold Pth with each other and determines the test state and the normal state based on a result of the comparison. Details of the determination function will be described below.

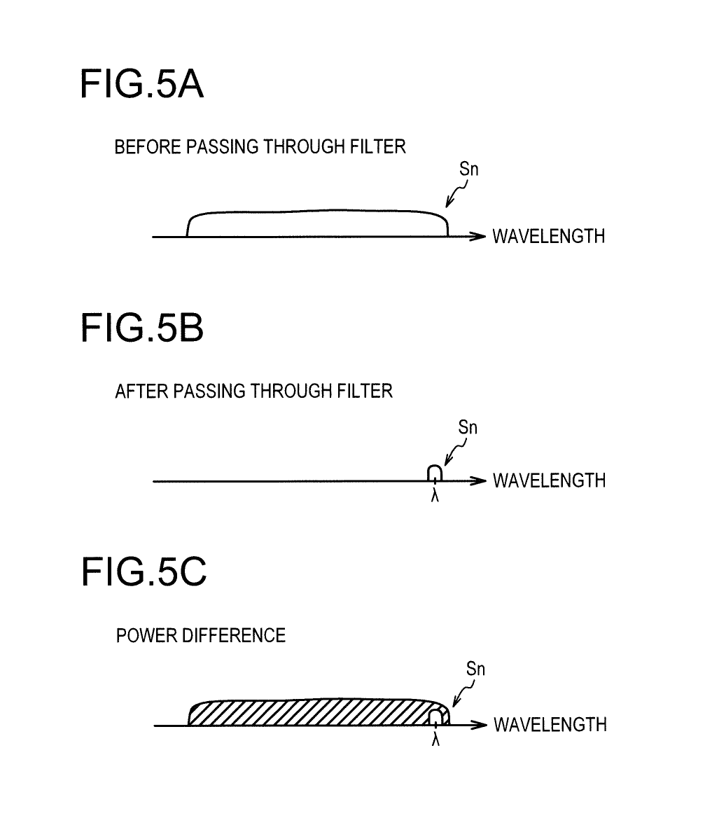

First, regarding the normal state, FIG. 5A illustrates an example of a wavelength spectrum of the ASE light Sn before passing through the filter 100, and FIG. 5B illustrates an example of a wavelength spectrum of the ASE light Sn after passing through the filter 100. As understood from a comparison between FIG. 5A and FIG. 5B, the filter 100 passes a light component of the ASE light Sn, which has a wavelength (λ) band of the test optical signal Sx. In addition, the power of the ASE light Sn after passing through the filter 100 is lowered due to the attenuation by the VOA 101.

FIG. 5C illustrates an example of a difference ΔP between the power of the ASE light Sn before passing through the filter 100 and the power of the ASE light Sn after passing through the filter 100. In FIG. 5C, the hatched portion represents the difference ΔP between the power of the ASE light Sn before passing through the filter 100 and the power of the ASE light Sn after passing through the filter 100. Since the filter 100 passes a light component of the ASE light Sn, which has a wavelength (λ) band, there occurs the difference ΔP between the power of the ASE light Sn before passing through the filter 100 and the power of the ASE light Sn after passing through the filter 100.

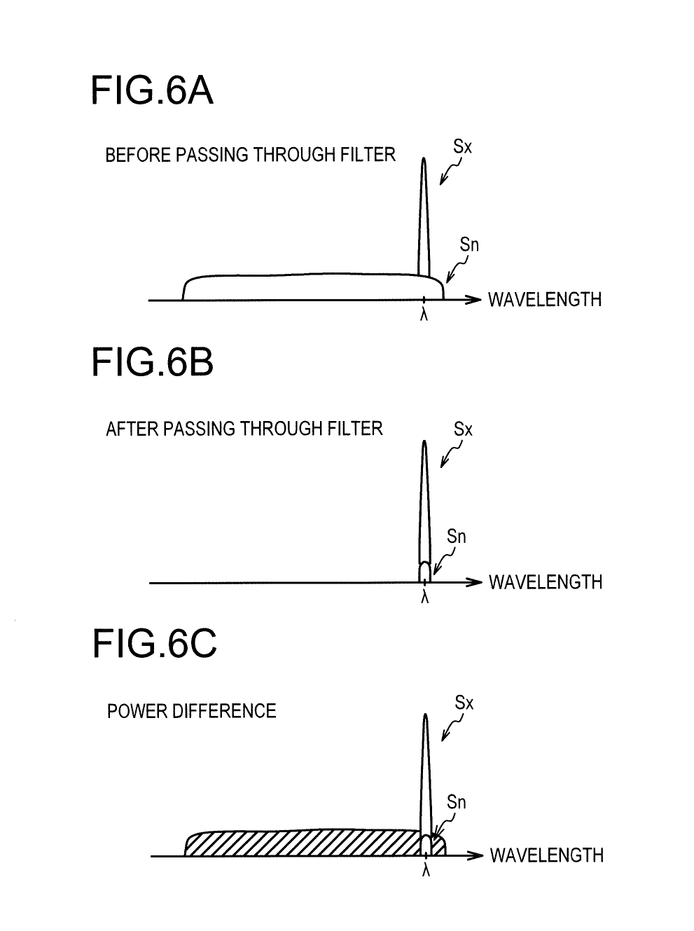

Next, regarding the test state, FIGS. 6A and 6B illustrate exemplary wavelength spectra of the ASE light Sn and the test optical signal Sx before and after passing through the filter 100, respectively. The test optical signal Sx is input to the filter 100 in a state of being mixed with the ASE light Sn.

As understood from a comparison between FIGS. 6A and 6B, the filter 100 passes a light component of the ASE light Sn, which has the wavelength (λ) band of the test optical signal Sx. In addition, the power of the ASE light Sn after passing through the filter 100 is lowered due to the attenuation by the VOA 101.

In addition, since the test optical signal Sx has the wavelength (λ) band, which corresponds to the transmission band of the filter 100, the wavelength (λ) band is not be cut, unlike the ASE light Sn. In addition, the power of the test optical signal Sx after passing through the filter 100 is lowered due to the attenuation by the VOA 101.

FIG. 6C illustrates an example of a difference in the power of the ASE light Sn before and after passing through the filter 100 and a difference in the power of the test optical signal Sx before and after passing through the filter 100. In FIG. 6C, the hatched portion represents the difference ΔP of the power of the ASE light Sn before and after passing through the filter 100. Since the filter 100 passes a light component of the ASE light Sn, which has the wavelength (λ) band, there occurs the difference ΔP in the power of the ASE light Sn before and after passing through the filter 100. However, since the test optical signal Sx passes through the filter 100 without causing the wavelength band thereof to be cut, the difference ΔP is smaller than that in the normal state. Hereinafter, a measurement example will be described.

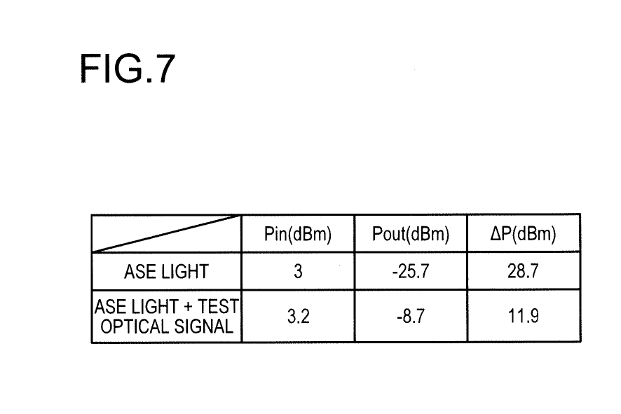

FIG. 7 illustrates an example of a measurement of the difference ΔP in the power before and after passing through the filter 100. For the normal state (see the column “ASE light”), the power Pin measured by the input power measuring circuit 12 is 3 (dBm), and the power Pout measured by the output power measuring circuit 13 is −25.7 (dBm). Therefore, the difference ΔP between the power Pin and the power Pout is 28.7 (dBm).

For the test state (see the column “ASE light +Test optical signal”), the power Pin measured by the input power measuring circuit 12 is 3.2 (dBm), and the power Pout measured by the output power measuring circuit 13 is −8.7 (dBm). Therefore, the difference ΔP between the power Pin and the power Pout is 11.9 (dBm).

In this way, the difference ΔP between the power Pin and the power Pout in the test state is smaller than the difference ΔP between the power Pin and the power Pout in the normal state. Therefore, in this example, the threshold Pth may be set to, for example, 20 (dBm), and the controller 11 may determine that the transmission side optical cross-connect unit 1a is in the test state when ΔP≦20 (dBm). Meanwhile, the controller 11 may determine that the transmission side optical cross-connect unit 1a is in the normal state when ΔP>20 (dBm).

In this way, the controller 11 determines the test state and the normal state based on the difference ΔP between the power Pin and the power Pout. By controlling the VOA 101 according to the determination result, the controller 11 suppresses the receiver 19 from being damaged due to the test optical signal Sx.

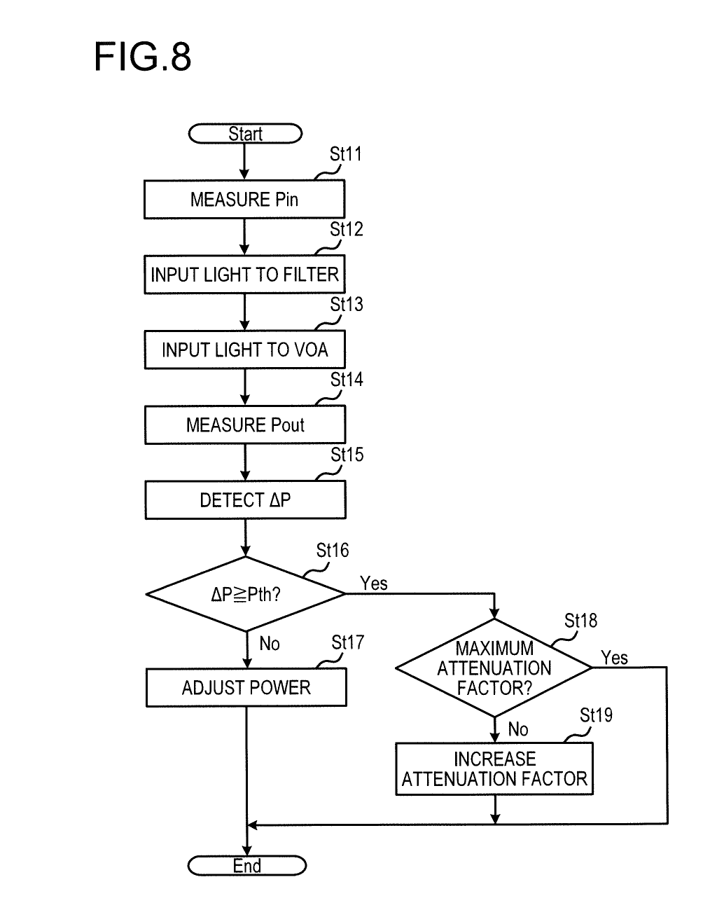

FIG. 8 is a flow chart illustrating an exemplary process of controlling the attenuation factor of the VOA 101. First, the input power measuring circuit 12 measures the power Pin of input light from an optical fiber before being passed by the filter 100 (Operation SUM.

Next, the input light from the optical fiber is input to the filter 100 (Operation St12). Accordingly, a light component of the input light, which has the same predetermined wavelength (λ) band as the test optical signal Sx, passes through the filter 100.

Next, the passed light component is input to the VOA 101 (Operation St13). Accordingly, the light component is attenuated.

Next, the output power measuring circuit 13 measures the power Pout of the light component attenuated by the VOA 101 (Operation St14). In this embodiment, the output power measuring circuit 13 measures the power Pout of the light component (ASE light Sn, or ASE light Sn+test optical signal Sx) received in the receiver 19.

Next, the difference detector 14 detects the difference ΔP between the measured power Pin and power Pout (Operation St15). At this time, the difference detector 14 notifies the difference ΔP to the controller 11.

Next, the controller 11 compares the difference ΔP with the predetermined threshold Pth (Operation St16). At this time, since the difference ΔP varies depending on the attenuation factor of the VOA 101, the controller 11 may set the threshold Pth according to the attenuation factor of the VOA 101.

When ΔP<Pth (No in Operation St16), the controller 11 adjusts the power of the test optical signal Sx by controlling the attenuation factor of the VOA 101 (Operation St17). More specifically, in the normal state, the controller 11 controls the attenuation factor of the VOA 101 such that the power Pout measured by the output power measuring circuit 13 reach the reference value of the receiver 19.

Accordingly, the controller 11 may adjust the power of the test optical signal Sx to an appropriate value according to the dynamic range of the receiver 19. This process corresponds to the process of Operation St4 of FIG. 3.

In addition, when ΔP≧Pth (Yes in Operation St16), the controller 11 determines whether or not the attenuation factor of the VOA 101 has a maximum value (Operation St18). When it is determined that the attenuation factor of the VOA 101 does not have a maximum value (No in Operation St18), the controller 11 increases the attenuation factor of the VOA 101 (Operation St19). The increase amount of the attenuation factor is determined based on, for example, the power of the test optical signal Sx.

Accordingly, since the attenuation factor of the VOA 101 at the input time of the test optical signal Sx may be set to a high value, the test optical signal Sx is input to the receiver 19 after being sufficiently attenuated. As a result, since the power of the test optical signal Sx becomes lower than the standard value of the receiver 19, there is no possibility of damage to the receiver 19.

Meanwhile, when it is determined that the attenuation factor of the VOA 101 has a maximum value (Yes in Operation St18), since the attenuation factor cannot be increased, the process is ended. Even in this case, since the test optical signal Sx is input to the receiver 19 after being sufficiently attenuated, the receiver 19 may be suppressed from being damaged. In this way, the process of controlling the attenuation factor of the VOA 101 is carried out.

In this embodiment, the controller 11 determines the test state and the normal state based on the difference ΔP between the power Pin and the power Pout, but the controller 11 may determine the test state and the normal state based on the ratio Pr of the power Pout to the power Pin. In this case, the difference detector 14 of FIG. 2 detects the ratio Pr of the power Pout measured by the output power measuring circuit 13 to the power Pin measured by the input power measuring circuit 12, instead of the difference ΔP. The difference detector 14 notifies the ratio Pr to the controller 11.

When the ratio Pr is equal to or smaller than a predetermined threshold Pth', the controller 11 increases the attenuation factor of the VOA 101. Therefore, since the test optical signal Sx is input to the receiver 19 after being sufficiently attenuated, the receiver 19 is suppressed from being damaged.

Meanwhile, when the ratio Pr is larger than the predetermined threshold Pth', the controller 11 controls the attenuation factor of the VOA 101 such that the power Pout measured by the output power measuring circuit 13 has the reference value. Therefore, the controller 11 may adjust the power of the test optical signal Sx to an appropriate value according to the dynamic range of the receiver 19.

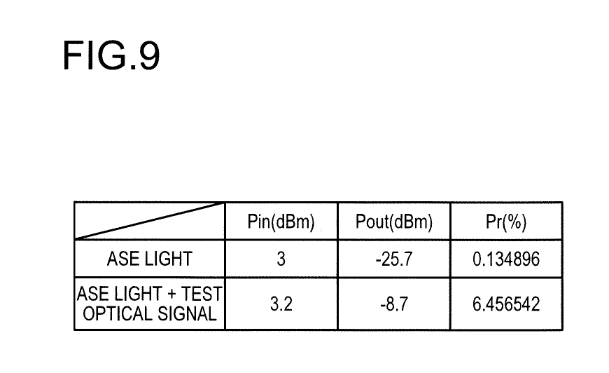

FIG. 9 illustrates a measurement example of the ratio Pr of the power Pin and the power Pout before and after passing through the filter 100. In FIG. 9, the power Pin and the power Pout have the same values as those in the example of FIG. 7.

Pr=(Pout′/Pin′)×100 (1)

The ratio Pr is calculated according to the above equation (1). The numerical values Pin′ and Pout′ are obtained by converting the power Pin and the power Pout into Watts (W). According to the equation (1), Pr=0.134896(%) for the normal state (see the column “ASE light”), and Pr=6.456542(%) for the test state.

In this way, the ratio Pr of the power Pin and the power Pout in the test state is larger than the ratio Pr of the power Pin and the power Pout in the normal state. Therefore, in this example, the threshold Pth' may be set to, for example, 1(%), and the controller 11 may determine that the transmission side optical cross-connect unit 1a is in the test state when Pr>1(%). Meanwhile, the controller 11 may determine that the transmission side optical cross-connect unit 1a is in the normal state when Pr≦1(%).

In this way, the controller 11 determines the test state and the normal state based on the ratio Pr in the same manner as the case of using the difference ΔP between the power Pin and the power Pout. By controlling the VOA 101 according to the determination result, the controller 11 suppresses the receiver 19 from being damaged due to the test optical signal Sx.

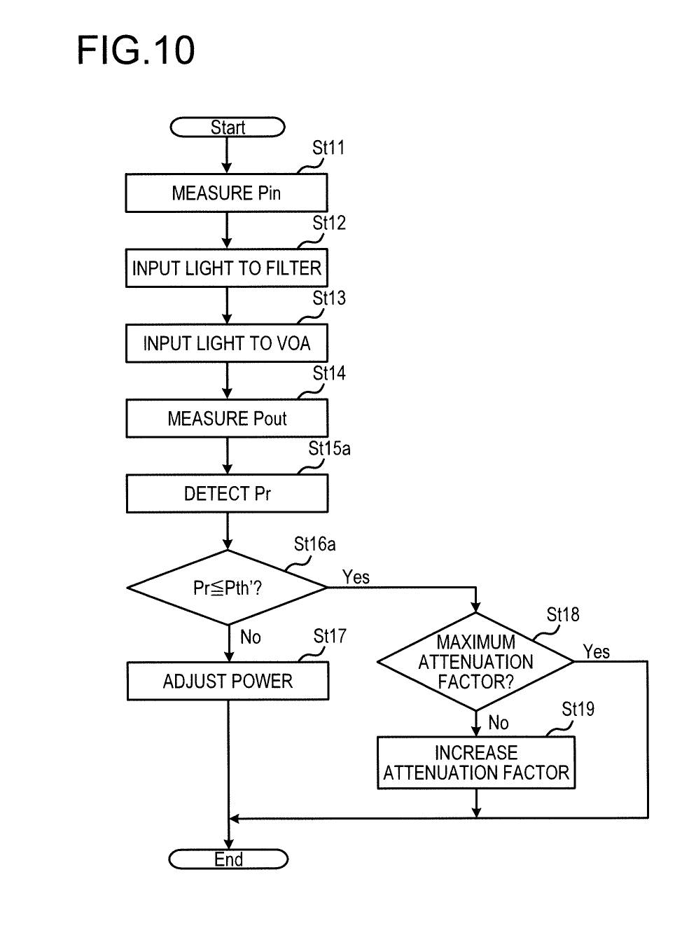

FIG. 10 is a flow chart illustrating another exemplary process of controlling the attenuation factor of the VOA 101. In FIG. 10, the same operations as in FIG. 8 will be denoted by the same reference symbols as used in FIG. 8, and explanation thereof will be omitted.

After measuring the power Pin and the power Pout, the difference detector 14 detects the ratio Pr of the power Pout to the power Pin (Operation St15a). At this time, the difference detector 14 notifies the ratio Pr to the controller 11.

Next, the controller 11 compares the ratio Pr with the predetermined threshold Pth′ (Operation St16a). At this time, since the ratio Pr varies depending on the attenuation factor of the VOA 101, the controller 11 may set the threshold Pth′ according to the attenuation factor of the VOA 101.

When Pr>Pth′ (No in Operation St16a), the controller 11 adjusts the power of the test optical signal Sx by controlling the attenuation factor of the VOA 101 (Operation St17). More specifically, in the normal state, the controller 11 controls the attenuation factor of the VOA 101 such that the power Pout measured by the output power measuring circuit 13 has the reference value of the receiver 19.

Accordingly, the controller 11 may adjust the power of the test optical signal Sx to an appropriate value according to the dynamic range of the receiver 19. This process corresponds to the process of Operation St4 of FIG. 3.

In addition, when Pr≦Pth′ (Yes in Operation St16a), the controller 11 determines whether or not the attenuation factor of the VOA 101 has a maximum value (Operation St18). When it is determined that the attenuation factor of the VOA 101 does not have a maximum value (No in Operation St18), the controller 11 increases the attenuation factor of the VOA 101 (Operation St19). The increase amount of the attenuation factor is determined based on, for example, the power of the test optical signal Sx.

Accordingly, since the attenuation factor of the VOA 101 at the input time of the test optical signal Sx may be set to a high value, the test optical signal Sx is input to the receiver 19 after being sufficiently attenuated. As a result, since the power of the test optical signal Sx becomes lower than the standard value of the receiver 19, there is no possibility of damage to the receiver 19.

Meanwhile, when it is determined that the attenuation factor of the VOA 101 has a maximum value (Yes in Operation St18), since the attenuation factor cannot be increased, the process is ended. Even in this case, since the test optical signal Sx is input to the receiver 19 after being sufficiently attenuated, the receiver 19 is suppressed from being damaged. In this way, the process of controlling the attenuation factor of the VOA 101 is carried out.

In this embodiment, the controller 11 determines the test state and the normal state based on the ratio Pr of the power Pout to the power Pin, but the controller 11 may determine the test state and the normal state based on a ratio Pr of the power Pin to the power Pout. In this case, the controller 11 performs power adjustment of the test optical signal Sx when Pr≦Pth′ and increases the attenuation factor.

As described so far, the ROADM device according to an embodiment is an example of the transmission apparatus and includes the transmission side optical cross-connect unit 1a and the reception side optical cross-connect unit 1b. The transmission side optical cross-connect unit is transmits the test optical signal Sx having the predetermined wavelength λ. The reception side optical cross-connect unit 1b receives the test optical signal Sx from the transmission side optical cross-connect unit is via the optical fiber Rb.

The reception side optical cross-connect unit 1b includes the filter 100, the VOA 101, the input power measuring circuit 12, the output power measuring circuit 13, the difference detector 14, and the controller 11. The filter 100 passes a light component of the light input from the optical fiber Rb, which has the predetermined wavelength (λ) band. The VOA 101 attenuates the light component.

The input power measuring circuit 12 measures the power Pin of the input light before being passed by the filter 100. The output power measuring circuit 13 measures the power Pout of the light component after being attenuated by the VOA 101.

The difference detector 14 detects the difference ΔP between the power Pin measured by the input power measuring circuit 12 and the power Pout measured by the output power measuring circuit 13. When the difference ΔP is equal to or larger than the predetermined threshold Pth, the controller 11 increases the attenuation factor of the VOA 101.

With the above-described configuration, the controller 11 may determine the presence/absence of the test optical signal Sx based on the difference ΔP between the power Pin measured by the input power measuring circuit 12 and the power Pout measured by the output power measuring circuit 13. Therefore, by setting the attenuation factor of the VOA 101 at the input time of the test optical signal Sx to a high value, the test optical signal Sx is input to the receiver 19 after being sufficiently attenuated. As a result, since the power of the test optical signal Sx becomes lower than the standard value of the receiver 19, there is no possibility of damage to the receiver 19.

In addition, the ROADM device according to another embodiment is an example of the transmission apparatus and includes the transmission side optical cross-connect unit 1a and the reception side optical cross-connect unit 1b. The transmission side optical cross-connect unit is transmits the test optical signal Sx having the predetermined wavelength λ. The reception side optical cross-connect unit 1b receives the test optical signal Sx from the transmission side optical cross-connect unit 1a via the optical fiber Rb.

The reception side optical cross-connect unit 1b includes the filter 100, the VOA 101, the input power measuring circuit 12, the output power measuring circuit 13, the difference detector 14, and the controller 11. The filter 100 passes the light component of the light input from the optical fiber Rb, which has the predetermined wavelength (λ) band. The VOA 101 attenuates the light component.

The input power measuring circuit 12 measures the power Pin of the input light before being passed by the filter 100. The output power measuring circuit 13 measures the power Pout of the light component after being attenuated by the VOA 101.

The difference detector 14 detects the ratio Pr of the power Pout measured by the output power measuring circuit 13 to the power Pin measured by the input power measuring circuit 12. When the ratio Pr is equal to or smaller than the predetermined threshold Pth′, the controller 11 increases the attenuation factor of the VOA 101.

According to the above-described configuration, since the controller 11 may determine the presence/absence of the test optical signal Sx based on the ratio Pr of the power Pout measured by the output power measuring circuit 13 to the power Pin measured by the input power measuring circuit 12, the same acting effects as described above may be achieved.

In addition, the optical fiber connection confirming method according to an embodiment is a method for transmitting the test optical signal Sx having the predetermined wavelength λ from the transmission side optical cross-connect unit 1a via the optical fiber Rb and receiving the test optical signal Sx in the reception side optical cross-connect unit 1b.

The reception side optical cross-connect unit 1b passes the light component of the light input from the optical fiber, which has the predetermined wavelength (λ) band, through the filter 100, and attenuates the light component by means of the VOA 101. In addition, the reception side optical cross-connect unit 1b measures the power Pin of the input light before being passed by the filter 100, measures the power Pout of the light component after being attenuated by the VOA 101, and detects the difference ΔP between the measured power Pin and power Pout. In addition, when the difference ΔP is equal to or larger than the predetermined threshold Pth, the reception side optical cross-connect unit 1b increases the attenuation factor of the VOA 101.

The optical fiber connection confirming method according to one embodiment may achieve the same acting effects as described above since the method includes the same configurations as the above-described ROADM device.

The above embodiments are not intended to have a limited sense but may be modified and practiced in various ways without departing from the spirit and scope of the invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus comprising:
a filter configured to pass an optical signal having a predetermined wavelength received via an optical fiber;
a variable optical attenuator configured to attenuate a power level of the optical signal passed by the filter;
a first measuring circuit configured to measure a first power of the optical signal before being passed by the filter;
a second measuring circuit configured to measure a second power of the optical signal attenuated by the variable optical attenuator;
a detector configured to detect a difference between the first power and the second power; and
a controller configured to increase an attenuation factor of the variable optical attenuator when the difference is equal to or larger than a first predetermined value.

2. The transmission apparatus according to claim 1, wherein, when the difference is smaller than the first predetermined value, the controller controls the attenuation factor such that the second power becomes to a first predetermined amount.

3. The transmission apparatus according claim 1,
wherein the detector detects a ratio of the second power to the first power, and
wherein the controller increases the attenuation factor when the ratio is equal to or smaller than a second predetermined value.

4. The transmission apparatus according to claim 3, wherein, when the ratio is larger than the second predetermined value, the controller controls the attenuation factor such that the second power becomes to a second predetermined amount.

5. A method for confirming connection of an optical fiber, the method comprising:
passing an optical signal having a predetermined wavelength received via the optical fiber, by a filter;
attenuating a power level of the optical signal passed by the filter, by a variable optical attenuator;
measuring a first power of the optical signal before being passed by the filter;
measuring a second power of the optical signal after being attenuated by the variable optical attenuator;
detecting a difference between the first power and the second power, by a detector; and
increasing an attenuation factor of the variable optical attenuator when the difference is equal to or larger than a first predetermined value, by a controller.

6. The method according to claim 5, wherein, when the difference is smaller than the first predetermined value, the controller controls the attenuation factor such that the second power becomes to a first predetermined amount.

7. The method according to claim 5
wherein the detector detects a ratio of the second power to the first power, and
wherein controller increases the attenuation factor when the ratio is equal to or smaller than a second predetermined value.

8. The method according to claim 7, wherein, when the ratio is larger than the second predetermined value, the controller controls the attenuation factor such that the second power becomes to a second predetermined amount.
